(19) United States
(12) Patent Application Publication
(10) Pub. No.: US 2012/0047482 A1
(43) Pub. Date: Feb. 23, 2012

(54) Use of Structures/Statistics in Software Optimization

(76) Inventors: Lioudmila Dyer, Davenport, FL (US); Stuart Dyer, Davenport, FL (US); Valerie Sibirsky, Reston, VA (US)

(21) Appl. No.: 13/205,621

(22) Filed: Aug. 9, 2011

Related U.S. Application Data
(60) Provisional application No. 61/374,679, filed on Aug. 18, 2010.

(51) Int. Cl. G06F 9/44

(52) U.S. Cl. 717/100

(57) ABSTRACT

Software optimization method, which uses Structures/Statistics, results in a product of an optimal operating cost and benefit to the end-user.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention is in the technical field of software applications for computers and automated devices.

Capabilities of modern computer programs and hardware allow solving economic problems of very large dimensions. However, this advantage can become a drawback if one does not take into the consideration the fact that specific economic problems of large dimensions have a structure (in a simple example—statistics) and the generality approach, that does not take structure/statistics into account, is wasteful. In light of this, it is imperative to uncover the structure/statistics (from here on referred to as “structure”) of the problem to be programmed, which would allow to significantly simplify the use of the resulting software.

### BRIEF SUMMARY OF THE INVENTION

The present invention offers a method for creating a software application (for computer or automated device) of an optimal programming and operating cost as well as an optimal benefit to the end-user.

### BRIEF DESCRIPTION OF THE DRAWINGS

FIG. 1A & 1B: Matrix and graph of connections, correspondingly, of the economic system, in which all the elements are interconnected.

FIG. 2A & 2B: Matrix and graph of connections, correspondingly, of the economic system, in which the internal connections of the subsystems are absent, as well as their connection to the center.

FIG. 3A & 3B: Matrix and graph of connections, correspondingly, of the economic system, in which the internal connections of the subsystems are absent, however, some of the subsystems have a connection with the center.

FIG. 4A & 4B: Matrix and graph of connections, correspondingly, of the economic system, in which the internal connections of some subsystems are present, as well as their connection with the center.

### DETAILED DESCRIPTION OF THE INVENTION

In general, any economic system with N elements could be represented as a square matrix of N×N size, where each matrix element aᵢⱼ represents a presence (aᵢⱼ=1) or absence (aᵢⱼ=0) of a connection between system elements i and j.

By fixing the existence or absence of connection between the elements we can represent the system of elements with their connections in the form of a symmetrical graph. Every node represents an element of the system and a segment between the nodes represents the existence of connection between them.

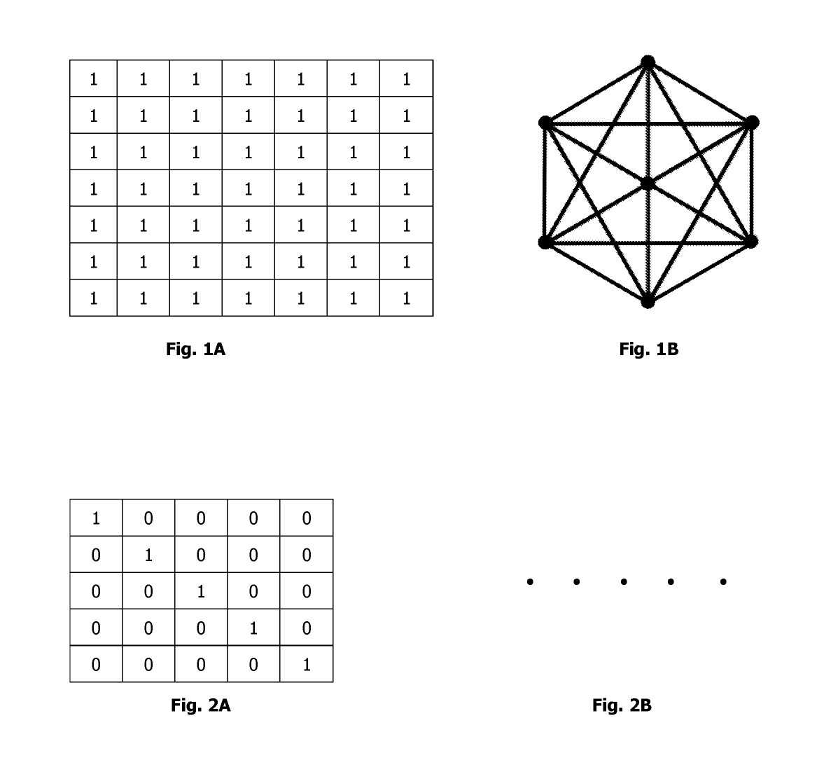

Generality approach presumes that all the elements are interconnected, i.e. V=1 (FIG. 1). With such an approach the analysis of the system is quite difficult, because we have a big matrix filled with 0's and 1's in disorder. The structure of the system would not be visible.

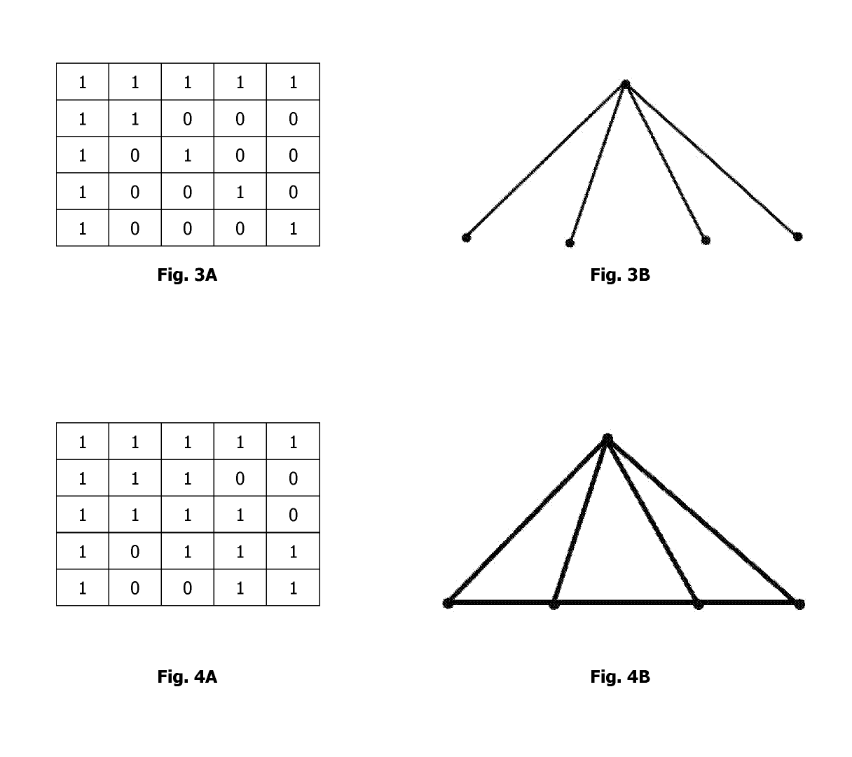

However, after some processing of the matrix by simultaneously rearranging rows and columns of connections, the structure will be easily identifiable by the arrangement of 0's and 1's. We would have to renumber the matrix elements and it will become evident which elements have many connections and which have a few. Examples of graph matrices after the rearrangement and renumbering of system elements are given in FIGS. 3 and 4.

By doing so, we reduce the original matrix to the size, which is minimal, but enough to fully describe the economic system in question.

The top rows and left columns of the matrix in FIG. 4 represent connections with the center (where the elements with the maximum number of connections are pulled to), and diagonal blocks are sequentially interconnected with each other. The rest of the elements are equal to 0. Matrices in FIGS. 2 and 3 are contained in the matrix in FIG. 4, and it has been proven mathematically that every specific economic problem could be represented by the matrix in FIG. 4.

Article by Gavrilets Y. N. called “The Structure of Multidimensional Random Variables and its Utilization in Social Research. Quantitative Sociology, International Perspectives on Mathematical and Statistical Modeling,” 1975. ACADEMIC PRESS. INC, New York—San Francisco—London, mentions modeling of statistical (probabilistic) systems. A book by Gavrilets Y. N. called “Social-economic planning. Systems and models,” Moscow, publishing house ‘Economics’, 1974, also mentions the possibility of analyzing structures of deterministic systems, and which was a topic of the article by “Kharchuk (Dyer) L. V. called “Set structure and ways to use it in specific planning problems. Models and methods of research of the social economic processes.” Central Economic-Mathematical Institute, ACADEMY OF SIENCES, USSR, Moscow,” 1975.

In substantial terms the above-mentioned publications show that direct connections between the elements of the complex economic system, containing a large number of elements, are mainly determined by the internal connections of some number of this system's sub-systems of significantly smaller dimensions, and by the connections of these sub-systems with the center. Or, in other words, if it is known that a specific matrix has a large number of elements equal to zero (which is characteristic to specific economic problems), we can re-arrange its elements in a certain order, thereby reducing its dimensions. As a result, when designing software, which utilizes an economic system, the optimal way is to build a structure based on the statistical data available on these system rather than base it on a much wider general case.

The analysis and reduction of structure of any given problem allows to significantly simplify programming, reducing the dimensions of the system at any given point. Therefore, in order to solve a specific, practical problem, a much less information is required at the time of programming, program execution, input, operation, and output.

If software developer doesn't undertake a specific research of problem's structure, he or she is assuming that software has to process all the elements of the matrix, even though a significant number of those elements are equal to zero. This will lead to the loss of software performance, to the inconvenience of data input, and to the inconvenience of output analysis.

Software developer should take into account that with the use of structures he or she can optimize the software, not merely implement the general case.

Let is consider some simple examples of failure to perform the structure analysis of specific problems:
Random or alphabetical (or convenient to the software developer) order of program functions—for example, <<My Favorites>> list at www.yahoo.com is sorted in alphabetical order and is far from user's preference, which can easily be derived from the statistics of selection frequency for specific options (application of example IV-a below).
Report printing without consideration of the fact that a significant number of output parameters are equal to zero, sometimes even entire rows or columns of zero values. A simple exclusion of zero values (especially entire rows and columns) from the report would allow to not only extend the use of the cartridge and save paper, but to also simplify the analysis of output (application of example II below).

For example, most big stores and supermarket chains require typical basic reports. To be more specific, let us consider the matrix in one of such typical reports (of a big supermarket chain) called “Long/short register report”. It contains 11 non-zero rows and 24 zero rows, 61 non-zero columns and 25 zero columns. Thus, it is possible to use 5 times less paper to output information on a daily basis, which could be achieved by a simple re-numeration of matrix elements. Similar is the situation with “Bank Card Transaction Report”—information on the existence of a cash-back amount contains only 1% of non-zero values, but the generality approach to information output, which does not take into account structure of the data, results in wasteful output of 99% of zeroes.
“Change order” bank requests are just as typical and are used when the store needs to request the currency and coins from the bank. List of denominations in “Change order” looks as following: Pennies, Nickels, Dimes, Quarters, Half Dollars, Silver Dollars, Ones, Fives, Tens, Twenties. Since Half dollars and Silver dollars are virtually never used in real queries it leads to the loss of the employee's time every time he or she has to go through these unused denominations to get to the ones following them (application of example I below).
Random or missing cursor positioning or selection. For example, when user right-clicks on Microsoft Word document—a pop-up menu lists several operations without selecting the most frequently used “Open” operation (application of example IV-b below).
Another example describes the case, when data has to be entered into the form. If an error is found in one of the fields after the form is submitted—the cursor/selection needs to be positioned on the field with erroneous value (since user's next action is to correct the entry in this field), not on the first one (application of example III-b below).
A typical response to the result of computer operation without consideration of the result's structure/statistics. A good example is the opening of a cash register after each transaction. In order to program this cash register operation in an optimal way it is necessary to take into account the statistics of cash and non-cash transactions. According to the statistics, 50% of transactions do not involve cash and, therefore, 50% of the time the cash register opens, when there is no need for an open cash register. (Now that paychecks could be deposited to a debit card account, the amount of no cash transaction will increase even more.) This operation could be programmed, so that the cash register opens only when there is a cash transaction (application of example III-a below).

It is necessary to mention that statistics analysis is one of the simpler ways of the use of specific problem's structure, a case when we have a matrix consisting of one row with elements sorted in a certain set order, for example, by the frequency the function is used. And the simplest case is when we are dealing with just one element. The generality principle, which does not consider structure/statistics, doesn't work well even in this simplest case.

In any case, it is important to check the specific economic problem for possibility of using its structure and there exist specific algorithms, which ensure that such an approach is effective.

Let us consider just two of the above-mentioned examples—random cursor positioning and cash register opening at the end of transaction. Generality (failure to consider the specifics of the problem) sets the cursor in a random position, even though a simple question “why randomly?” will lead to reconsideration and to a decision to position the cursor on the most used option, which will result in time savings. A second example will not only result in saving time and electric energy, but will also offer an additional safety measure.

In both cases software developer made an arbitrary decision without considering the structure/statistics (specifics) of the problem, while the end-user was not aware that there was a possibility of optimization. Only the rejection of generality approach and use of the structure/statistics of the specific problem will yield the maximum optimization of the software.

In addition to determining problem's structure prior to software development stage, one could accumulate statistics and determine the structure at the prototype or testing stage.

There is also an option of creating a built-in dynamic optimization module designed to automatically adjust software settings/options based on the data collected during actual software use. In other words, determination or improvement of problem's structure leading to product optimization is possible throughout the software development lifecycle. Here are some examples:
I. Initial System Design Stage: System Developers communicate with End-Users to identify/collect System Requirements in order to determine problem's structure.
II. System Development Stage: System Developers develop the System and improve it based on the real data/statistics, which is either collected and provided by the End-User or collected by System Developers at the time of prototype System runs. I.e. real-time data/statistics is used to determine or improve problem's structure.
III. Quality Assurance/Testing Stage: The System is further improved based on the results of the test runs performed during the Quality Assurance Stage to determine or improve problem's structure.
   a. End-Users test the System and provide feedback.
   b. Technical Writers insert Flags in the Product Manual to accompany the System to be tested. These Flags let End-Users know about the possibility to change certain System options. End-users test the System paying specific attention to the Flags inserted in the Product Manual and provide feedback to System Developers.
IV. Post System Deployment Stage:
   a. Built-in Dynamic Optimization Module designed to automatically adjust Software settings/options/lists based on the data collected during actual System runs. Software is adjusted dynamically, as needed, depending on the actual System use.
   b. In addition to automatic optimization, offer end-users a possibility to manually modify some options of the completed and delivered System.

In conclusion, it should be stressed once more that in every software development practice it is important to examine the specific economic problem for a possibility to use its structure and it has been proven mathematically that such an approach will always produce beneficial results.

The same approach is necessary when developing sub-programs, and, obviously, simplification of the specific economic problem based on the use of its structure should be commensurable with the benefits derived from such simplification. It is important to note that the approach of the use of structure/statistics could be applied not just to economic problems, but to other problems as well.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

What is claimed is:

1. Unlike the traditional Generality Approach, which assumes that all elements of a system are interconnected, this new software optimization method:
a) uses structures (in simple cases, statistics) of specific problems of large dimensions at one, several, or all stages of the software development lifecycle;
b) is based on a well-known fact that square matrices describing specific problems (economic problems, for example) have a large number of elements equal to zero and is also based on the mathematical theorem proving that by simultaneously rearranging rows and columns of such matrices one can significantly reduce their dimensions to the size that is minimal, but sufficient to fully describe the system in question; and
c) allows to significantly simplify programming, reduce operating costs as well as provide an optimal benefit to the end-user.
